(19) United States
(12) Patent Application Publication
(10) Pub. No.: US 2018/0275828 A1
(43) Pub. Date: Sep. 27, 2018

(54) RECEIVING DEVICE AND DETECTION DEVICE

(71) Applicant: FUJI XEROX CO., LTD., Tokyo (JP)

(72) Inventors: Ko TAKEUCHI, Kanagawa (JP); Nozomi NOGUCHI, Kanagawa (JP); Asako TAKAYAMA, Kanagawa (JP); Shunsuke KODAIRA, Kanagawa (JP)

(73) Assignee: FUJI XEROX CO., LTD., Tokyo (JP)

(21) Appl. No.: 15/661,765

(22) Filed: Jul. 27, 2017

(30) Foreign Application Priority Data
Mar. 23, 2017 (JP) 2017-057993

(51) Int. Cl. G06F 3/042; G06F 3/041; H04N 1/00

(52) U.S. Cl. CPC G06F 3/0421; G06F 3/0416; H04N 2201/0094; H04N 1/00896; H04N 1/00424

(57) ABSTRACT

A receiving device includes an optical detector that detects a position of an object of interest to be detected by receiving, with the use of one or more light-receiving portions, reflected light that occurs when light emitted from one or more light-emitting portions is reflected by the object of interest; and a transition receiving portion that receives, based on a detection result detected by the optical detector, an user operation for causing an apparatus including the receiving device to transition from a first power state where power consumption of the apparatus is less to a second power state where the power consumption is greater. In the first power state, the optical detector activates one or more light-emitting portions and one or more light-receiving portions that are necessary for detecting a user operation on the transition receiving portion, and inactivates the rest that are unnecessary.

### CROSS-REFERENCE TO RELATED APPLICATIONS

This application is based on and claims priority under 35 USC 119 from Japanese Patent Application No. 2017-057993 filed Mar. 23, 2017.

### BACKGROUND

### (i) Technical Field

The present invention relates to a receiving device and a detection device.

### (ii) Related Art

A user interface of an apparatus may be provided with, as an input unit for receiving information for operating the apparatus, a hardware key, which is a key with a concrete form, such as a button or a switch, or a software key, which is a key displayed on a display under software control.

Meanwhile, a user interface that is provided with an optical detector for optically detecting the position of an object of interest to be detected and that receives an input from a user in accordance with the detected position of the object of interest may be used.

In a transition from a first power state such as a power saving state where power consumption is less to a second power state such as a normal state where power consumption is greater in response to a user operation, this operation may be detected using the optical detector.

In this case, however, because it is necessary to have the optical detector active even in the first power state, power consumed by the optical detector tends to be great.

### SUMMARY

According to an aspect of the invention, there is provided a receiving device including an optical detector and a transition receiving portion. The optical detector detects a position of an object of interest to be detected by receiving, with use of one or more of light-receiving portions, reflected light that occurs when light emitted from one or more of light-emitting portions is reflected by the object of interest to be detected. The transition receiving portion receives, based on a detection result detected by the optical detector, an operation performed by a user for causing an apparatus including the receiving device to transition from a first power state where power consumption of the apparatus is less to a second power state where the power consumption is greater. In the first power state, the optical detector activates one or more of the light-emitting portions and one or more of the light-receiving portions that are necessary for detecting an operation performed by the user on the transition receiving portion, and inactivates rest of the light-emitting portions and the light-receiving portions that are unnecessary.

### BRIEF DESCRIPTION OF THE DRAWINGS

An exemplary embodiment of the present invention will be described in detail based on the following figures, wherein:

FIG. 1 is an external view of an image forming apparatus according to an exemplary embodiment;

FIG. 2 is a diagram illustrating the internal configuration of the image forming apparatus according to the exemplary embodiment;

FIG. 3A is a diagram illustrating an exemplary user interface;

FIG. 3B is a cross-sectional view taken along line IIIB-IIIB of the user interface illustrated in FIG. 3A;

FIG. 4 is a diagram illustrating a method of detecting one or more objects of interest to be detected with the use of an optical detector;

FIG. 5 is a diagram illustrating a specific example of an operation performed by a user on a display;

FIG. 6 is a diagram illustrating a specific example of an operation performed by the user in a second detection region;

FIGS. 7A and 7B are diagrams illustrating the position of one or more light-emitting portions and one or more light-receiving portions to be activated;

FIG. 8 is a block diagram illustrating an exemplary functional configuration of a control device; and

FIG. 9 is a flowchart illustrating the operation of the control device.

### DETAILED DESCRIPTION

Hereinafter, an exemplary embodiment will be described in detail with reference to the attached drawings.

### Description of Overall Configuration of Image Forming Apparatus 1

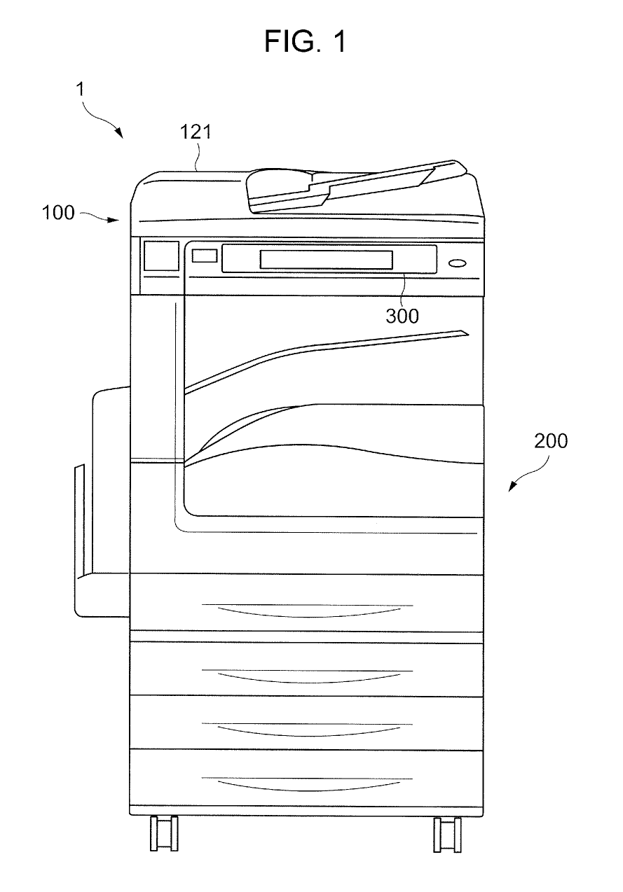

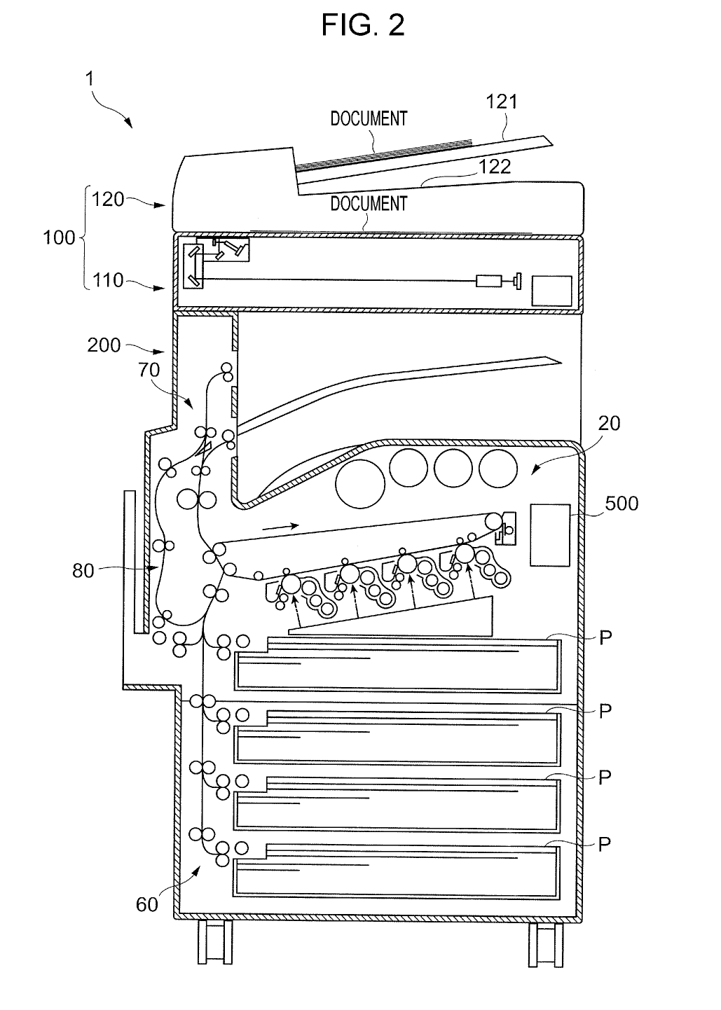

FIG. 1 is an external view of an image forming apparatus 1 according to the exemplary embodiment. FIG. 2 is a diagram illustrating the internal configuration of the image forming apparatus 1 according to the exemplary embodiment.

The image forming apparatus 1 includes an image reading device 100, which reads an image of a document, and an image recording device 200, which records an image on a recording material (hereinafter may be represented as “paper”). The image forming apparatus 1 additionally includes a user interface (UI) 300, which receives an operation input from a user and displays different items of information for the user. The image forming apparatus 1 further includes a control device 500, which controls the overall operation of the image forming apparatus 1.

The image reading device 100 is arranged in an upper portion of the image forming apparatus 1, and the image recording device 200 is arranged below the image reading device 100 and contains the control device 500. The user interface 300 is arranged on the front side of an upper portion of the image forming apparatus 1, that is, the front side of a later-described image reading unit 110 of the image reading device 100.

At first, the image reading device 100 will be described.

The image reading device 100 includes the image reading unit 110, which reads an image of a document, and a document conveying unit 120, which conveys the document to the image reading unit 110. The document conveying unit 120 is arranged in an upper portion of the image reading device 100, and the image reading unit 110 is arranged in a lower portion of the image reading device 100.

The document conveying unit 120 includes a document containing portion 121, in which a document is contained, and a document ejection portion 122, to which the document conveyed from the document containing portion 121 is ejected. The document conveying unit 120 conveys a document from the document containing portion 121 to the document ejection portion 122. The document conveying unit 120 is also referred to as an auto-document feeder (ADF).

Next, the image recording device 200 will be described.

The image recording device 200 includes an image forming unit 20, which forms an image on paper P, a paper supplying unit 60, which supplies paper P to the image forming unit 20, a paper ejecting unit 70, which ejects paper P on which an image has been formed by the image forming unit 20, and a reversing and conveying unit 80, which reverses paper P, on one side of which is formed an image by the image forming unit 20, and again conveys the paper P toward the image forming unit 20.

The user interface 300 is an example of a receiving unit (receiving device) that receives an instruction from a user for the apparatus (image forming apparatus 1), and includes an optical detector and a display, which will be described in detail later. The user interface 300 provides the user with different items of information through a screen displayed on the display, and, in response to an operation performed by the user on the screen, the optical detector detects that operation. An operation target such as a home button is provided outside the display, and, in response to an operation of the operation target performed by the user, the optical detector similarly detects that operation. As a result, the user is able to input an instruction to the image forming apparatus 1.

### Description of Operation of Image Forming Apparatus 1

The image forming apparatus 1 configured as described above operates as follows.

For example, the user is able to copy a document using the image forming apparatus 1. That is, a document may be copied on the basis of image data of the document read by the image reading device 100 by forming an image on paper P with the use of the image recording device 200. The user is also able to perform printing by transmitting a print job to the image forming apparatus 1 from, for example, a personal computer (PC) (not illustrated) connected to a communication link. That is, printing may be performed by receiving a print job through a communication link, and, on the basis of image data included in the print job, forming an image on paper P with the use of the image recording device 200. The user is further able to transmit and receive faxes. That is, image data of a document read by the image reading device 100 may be transmitted through a communication link. Alternatively, the user is able to save image data of a document. That is, image data of a document may be saved in the image forming apparatus 1 or in a PC connected to a communication link.

### Description of Power State of Image Forming Apparatus 1

The power state of the image forming apparatus 1 is set as one of the following two states: a power saving mode (first power state) in which the image forming apparatus 1 operates in a state where the power consumption of the image forming apparatus 1 is less; and a normal mode (second power state) in which the image forming apparatus 1 operates normally and the power consumption is greater.

Here, in the normal mode, a fixing device of the above-described image forming apparatus 1 operates normally. That is, the fixing device fixes an image at a normal fixing temperature.

The power saving mode is set as two types of power saving states, that is, a low power mode and a sleep mode, in the exemplary embodiment.

In the low power mode, the temperature of the fixing device is set as a temperature lower than that in the normal mode. In the sleep mode, the power of the fixing device is turned off, thereby stopping the power supply to the fixing device.

In the low power mode, the power consumption is less than that in the normal mode, thereby saving power of the image forming apparatus 1. Furthermore, in the sleep mode, the power consumption becomes yet less than that in the low power mode, thereby further saving power of the image forming apparatus 1.

In the low power mode and the sleep mode, the power supply not only to the fixing device but also to the other mechanisms of the image forming apparatus 1 may be stopped. For example, the power supply to a later-described display 320 may be stopped, thereby erasing an image displayed on the display 320.

Switching among the normal mode, the low power mode, and the sleep mode is performed by the control device 500. More specifically, the control device 500 switches the operating state of the image forming apparatus 1 to one of the normal mode, the low power mode, and the sleep mode in accordance with an instruction from the user and the operating conditions of the individual sections of the image forming apparatus 1. Accordingly, the power state of the image forming apparatus 1 becomes more suitable in accordance with the operating conditions, and the power consumption is reduced.

For example, when no operation is performed on the image forming apparatus 1 in the normal mode and a predetermined time period elapses, the control device 500 switches the mode from the normal mode to the low power mode. When no operation is performed further in the low power mode and a predetermined time period elapses, the control device 500 switches the mode from the low power mode to the sleep mode.

In contrast, for example, on receipt of a print job through a communication link in the low power mode or the sleep mode, the control device 500 switches the mode from this mode to the normal mode.

In the exemplary embodiment, the image forming apparatus 1 additionally adopts a manual transition system to transition from the power saving mode to the normal mode.

In the manual transition system, for example, the user interface 300 is provided with a button for transitioning from the power saving mode to the normal mode, and a mode transition occurs in response to a touch event on the button. This button is a home button, which will be described in detail later. Therefore, the home button functions as a transition receiving portion that receives an operation performed by the user for transitioning from the power saving mode to the normal mode.

### Description of User Interface 300

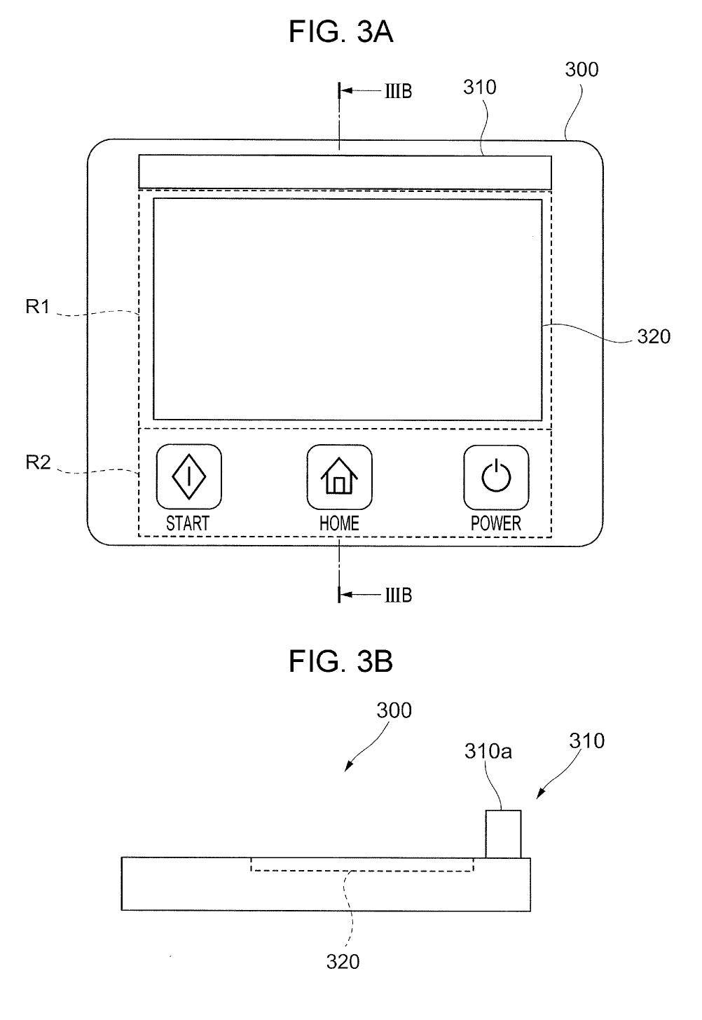

FIG. 3A is a diagram illustrating an example of the user interface 300. FIG. 3B is a cross-sectional view taken along line IIIB-IIIB of the user interface 300 illustrated in FIG. 3A.

As illustrated in FIG. 3A, the user interface 300 includes an optical detector 310, which optically detects an object of interest to be detected, and the display 320, which displays an image.

The optical detector 310 is also referred to as, for example, an optical sensing bar, and detects the position of an object of interest to be detected. When the user tries to operate the user interface 300, for example, if the user is operating the user interface 300 with a touch of a finger, the optical detector 310 detects this finger as an object of interest to be detected. The optical detector 310 is able to detect anything other than the user's finger as long as that thing touches the user interface 300. Therefore, for example, a stylus may serve as an object of interest to be detected.

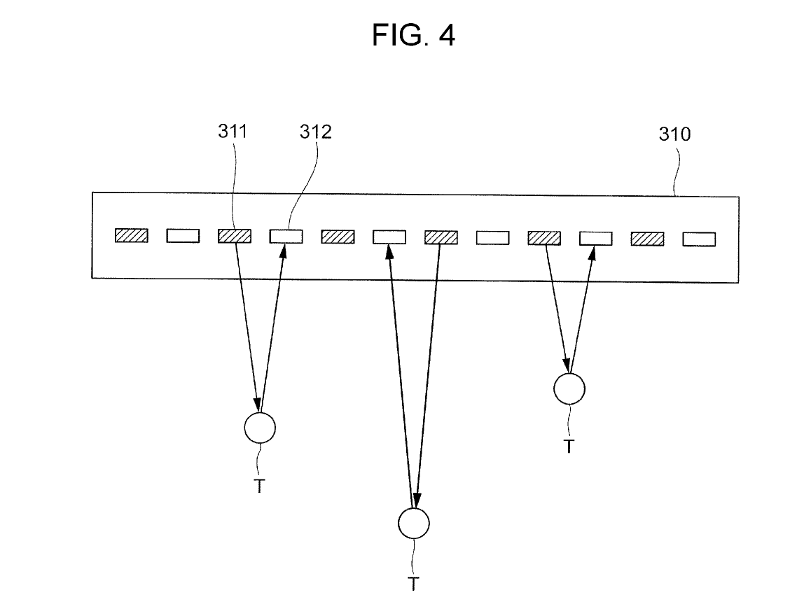

FIG. 4 is a diagram illustrating a method of detecting one or more objects T of interest to be detected with the use of the optical detector 310.

As illustrated in FIG. 4, the optical detector 310 includes light-emitting portions 311, which emit light, and light-receiving portions 312, which receive light.

Each light-emitting portion 311 includes a light-emitting diode (LED) or the like, and emits infrared light or the like.

Each light-receiving portion 312 includes a photodiode (PD) or the like, and receives light reflected from an object T of interest to be detected. Each light-receiving portion 312 outputs a detection signal in accordance with this reflected light.

As illustrated in FIG. 4, the light-emitting portions 311 and the light-receiving portions 312 are alternately arranged in line.

With this configuration, the optical detector 310 is able to detect the position of an object T of interest to be detected by receiving, with the use of one or more of the light-receiving portions 312, reflected light that occurs when light emitted from one or more of the light-emitting portions 311 is reflected by the object T of interest. This is, so to speak, the optical detector 310 being able to detect a two-dimensional position that is the position of an object T of interest to be detected in the vertical and horizontal directions. In other words, the horizontal position of an object T of interest to be detected in FIG. 4 is detectable by determining which of the light-receiving portions 312 has received reflected light, and the vertical position of the object T of interest in FIG. 4 is detectable in accordance with the intensity of the light received by that light-receiving portion 312. That is, the closer the object T of interest is to the optical detector 310, the greater the intensity of the light received by the light-receiving portion 312. In contrast, the farther the object T of interest is from the optical detector 310, the weaker the intensity of the light received by the light-receiving portion 312. Therefore, because the distance between the optical detector 310 and the object T of interest is detectable from the intensity of the light received by the light-receiving portion 312, the position of the object T of interest to be detected in the vertical direction of FIG. 4 is accordingly detectable. Furthermore, even if there are multiple objects T of interest to be detected, the optical detector 310 is able to detect the individual objects T of interest. Accordingly, the so-called multi-touch is detectable.

As illustrated in FIG. 3B, the optical detector 310 includes a protruding protrusion 310a on a face where the display 320 of the user interface 300 is provided. The light-emitting portions 311 and the light-receiving portions 312, illustrated in FIG. 4, are arranged on the protrusion 310a. Out of light emitted from the light-emitting portions 311, light that progresses along the face where the display 320 of the user interface 300 is provided hits an object T of interest to be detected and is reflected, thereby becoming reflected light. Out of the reflected light from the object T of interest, light that progresses along the face where the display 320 is provided is received by one or more of the light-receiving portions 312.

The display 320 is, for example, a liquid crystal panel, and displays information regarding the image forming apparatus 1 as an image. As illustrated in FIG. 3A, the display 320 is rectangular, and one optical detector 310 is arranged along one side of the display 320. Here, the optical detector 310 is arranged along the top side of the display 320.

In the exemplary embodiment, a first detection region R1 and a second detection region R2 are provided as detection regions for detecting an object T of interest to be detected with the use of the optical detector 310.

The first detection region R1 is provided closer to the optical detector 310 and is a region for detecting the movement of an object T of interest to be detected with the use of the optical detector 310.

Here, the first detection region R1 includes the area of the display 320, as illustrated in FIG. 3A. Therefore, the optical detector 310 is able to detect, in the first detection region R1, an operation performed by the user on an image displayed on the display 320.

In this case, because the optical detector 310 is able to detect the movement of an object T of interest to be detected on the display 320, the optical detector 310 is able to detect, in the first detection region R1, not only the presence of a touch event but also an operation involved in the touch as an operation performed by the user on the display 320. An operation involved in the touch is specifically an operation such as dragging or swiping performed by the user on the display 320. That is, when the optical detector 310 detects an object T of interest to be detected at a certain position on the display 320, it is determined that the user has touched the detected position on the display 320. Furthermore, when the detected position moves, it is determined that the user has performed an operation such as dragging or swiping on the display 320.

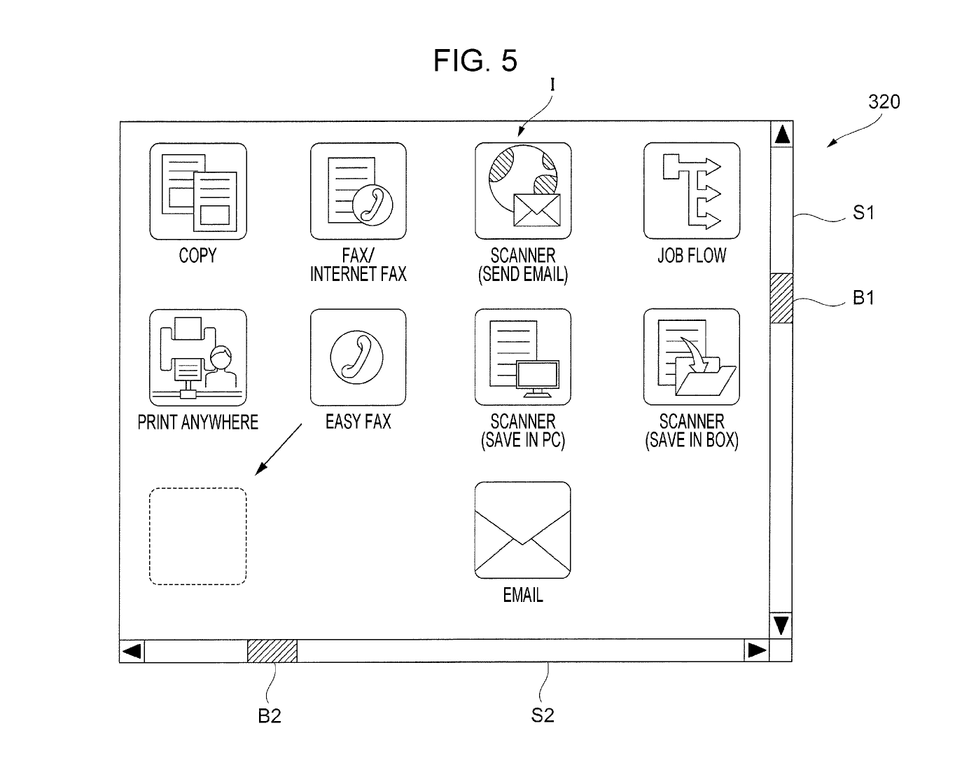

FIG. 5 is a diagram illustrating a specific example of an operation performed by the user on the display 320.

Here, a list of icons I for executing functions included in the image forming apparatus 1 is displayed as an image on the display 320. This image is a so-called home screen. The icons I displayed here are respectively associated with predetermined processes, and, when one of the icons I is selected, a process associated with the selected icon I is executed.

In the example illustrated in FIG. 5, the display 320 displays the icons I representing the following functions: copy, fax/Internet fax, scanner (send email), job flow, print anywhere, easy fax, scanner (save in PC), scanner (save in box), and email.

To use a function that the user wants to use, the user performs an operation to touch a corresponding one of the icons I. When the user touches one of the icons I, for example, a setup screen corresponding to the function associated with the icon I is displayed. For example, when the user touches the icon I of “copy”, the following setup screen for copying a document is displayed: a screen for selecting the number of copies, the type of paper to be used, and whether to perform monochrome or color printing, and setting the scale for enlargement or size reduction. After the setup, when the user touches a later-described start button, the actual copy operation starts.

When the user performs an operation to drag one of the icons I, this operation corresponds to moving that icon I. For example, when the user wants to move the icon I of “easy fax” to a position indicated by a dotted line, the user simply drags this icon I.

The display 320 additionally displays a scroll bar S1 for scrolling the screen vertically and a scroll bar S2 for scrolling the screen horizontally.

In this case, when the user touches one of black triangle marks included in the scroll bar S1 or the scroll bar S2, the user is able to scroll the screen in a direction indicated by that black triangle mark. When the user moves a scroll button B1 included in the scroll bar S1 or a scroll button B2 included in the scroll bar S2 by dragging the scroll button B1 or B2, the user is able to scroll the screen in a direction of that movement. By scrolling the screen, a screen not displayed on one screen may be displayed.

The second detection region R2 is provided farther from the optical detector 310 than the first detection region R1, and is a region for detecting whether there is an object T of interest to be detected with the use of the optical detector 310.

Accordingly, the optical detector 310 detects whether the user touches an operation target in the second detection region R2. In contrast, the optical detector 310 does not detect an operation involved in the touch, such as dragging or swiping, in the second detection region R2. An operation target is, for example, a button provided in the second detection region R2. Note that the button has no function as an electrical switch for turning on/off the power in response to pressing of the button. When the optical detector 310 detects an object T of interest to be detected in the second detection region R2, it is determined that the user has touched a button located at the detected position.

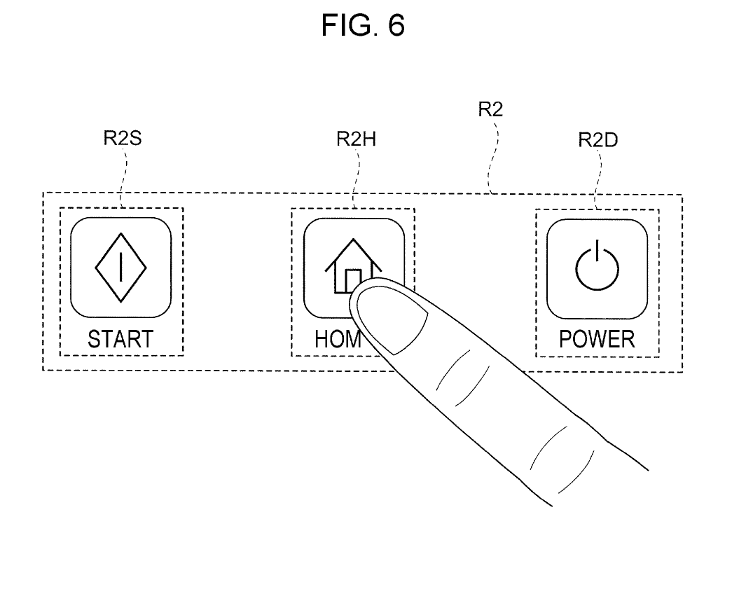

FIG. 6 is a diagram illustrating a specific example of an operation performed by the user in the second detection region R2.

In the example illustrated in FIG. 6, three buttons are arranged in the second detection region R2. These buttons are, from the left, a start button, a home button, and a power button. The start button is a button for starting the operation of the image forming apparatus 1. The home button is a button for causing the screen of the display 320 to transition to a home screen. The power button is a button for turning on/off the power of the image forming apparatus 1. FIG. 6 illustrates the case where the user has touched the home button, among these three buttons.

In the exemplary embodiment, an identification display element with which the user is able to recognize each button that serves as an operation target is provided at a position of this button or at a position adjacent to this button. Here, a frame representing the range of each button is printed as an identification display element. In addition, a mark representing the function of each button is printed within the frame as an identification display element. Furthermore, text representing the function of each button is printed below the frame as an identification display element. In the example illustrated in FIG. 6, frames, marks, and text representing that these buttons are, respectively from the left, the start button, the home button, and the power button are printed.

Regions for determining that the buttons are touched may be the illustrated frames, or may be regions containing these frames. That is, when the user touches a position within a predetermined range outside each of the frames, it is determined that the user has touched a corresponding one of the buttons. In FIG. 6, a region R2S is illustrated as a region for determining that the start button has been touched. In addition, a region R2H is illustrated as a region for determining that the home button has been touched, and a region R2D is illustrated as a region for determining that the power button has been touched.

Note that these identification display elements are not limited to those printed. For example, these buttons may be partially made light-transmissive, and LEDs or the like below the buttons emit light to illuminate the marks and the like. In addition, the functions of the buttons may be displayed at the lower side of the display 320. Furthermore, the marks and the like may be projected from the top.

In the exemplary embodiment, the home button is further provided with the function of receiving a user operation for causing the mode of the image forming apparatus 1 to transition from the power saving mode to the normal mode. In other words, when the user touches the home button in the case where the image forming apparatus 1 is in the power saving mode, the optical detector 310 detects this operation, and, as a result, the image forming apparatus 1 transitions from the power saving mode to the normal mode.

However, when all the functions of the optical detector 310 are activated in the power saving mode, the power consumption increases. Therefore, in the exemplary embodiment, only some of the functions of the optical detector 310 are activated to lower the power consumption. Specifically, the optical detector 310 activates one or more of the light-emitting portions 311 that emit light to an object T of interest to be detected on the home button and one or more of the light-receiving portions 312 that receive light reflected from the object T of interest on the home button, and inactivates the rest. In short, in the power saving mode, the optical detector 310 activates one or more of the light-emitting portions 311 and one or more of the light-receiving portions 312 that are necessary for detecting a user operation on the home button, and inactivates the rest of the light-emitting portions 311 and the light-receiving portions 312 that are unnecessary.

In the normal mode, all the light-emitting portions 311 and the light-receiving portions 312 are activated.

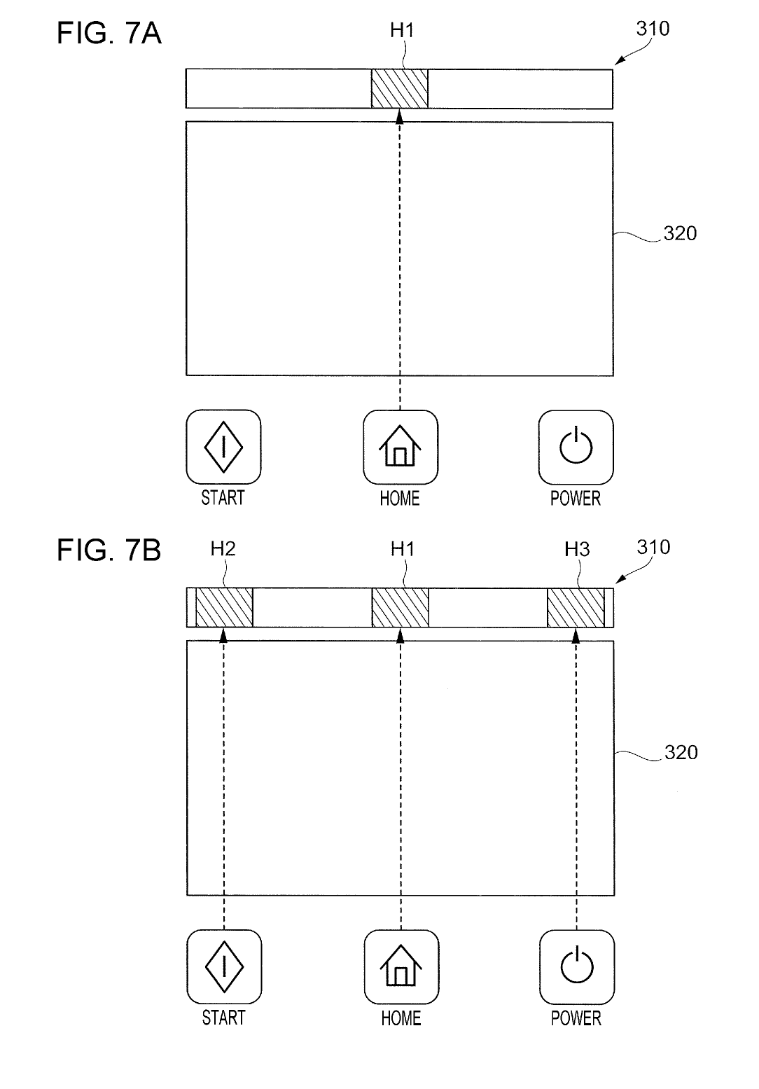

FIGS. 7A and 7B are diagrams illustrating the position of one or more of the light-emitting portions 311 and one or more of the light-receiving portions 312 to be activated.

FIG. 7A is a diagram illustrating the position of one or more of the light-emitting portions 311 and one or more of the light-receiving portions 312 (see FIG. 4) to be activated in the above-described case.

As illustrated in FIG. 7A, among the light-emitting portions 311 and the light-receiving portions 312 arranged in line on the optical detector 310, one or more light-emitting portions 311 and one or more light-receiving portions 312 arranged at a position H1 close to the center, which is a position immediately above the home button in FIG. 7A, are activated, and the rest of the light-emitting portions 311 and the light-receiving portions 312 at two end portions are inactivated.

The position of one or more light-emitting portions 311 and one or more light-receiving portions 312 to be activated may not necessarily be fixed, and may be changeable. For example, not all the light-emitting portions 311 and the light-receiving portions 312 arranged at the position H1 may be activated; instead, combinations of the light-emitting portions 311 and the light-receiving portions 312 may be grouped into predetermined blocks, and activation and inactivation may be repeated on a block by block basis. One or more combinations of the light-emitting portions 311 and the light-receiving portions 312 may belong to one block. Specifically, for example, one light-emitting portion 311 and one light-receiving portion 312 that are adjacent to each other may serve as one combination. On the first time, every three combinations are activated, and the other combinations in between are inactivated. On the second time, the combinations activated on the first time are inactivated, and the adjacent combinations are activated. On the third time, the combinations activated on the second time are inactivated, and yet the adjacent combinations are activated. On the next time, the state returns to the first time. In doing so, activation and inactivation may be repeated on a block by block basis.

The position of light-emitting portions 311 and light-receiving portions 312 that are repeatedly activated and inactivated is not necessarily fixed to the position H1.

FIG. 7B is a diagram illustrating the case where the position of light-emitting portions 311 and light-receiving portions 312 to be activated changes to positions other than the position H1.

Here, all of the start button, the home button, and the power button serve as transition receiving portions that receive a user operation for causing the image forming apparatus 1 to transition from the power saving mode to the normal mode. In other words, the transition receiving portions are provided along a direction in which the light-emitting portions 311 and the light-receiving portions 312 are arranged (in this case, the horizontal direction of FIG. 7B). The light-emitting portions 311 and the light-receiving portions 312 arranged not only at the position H1, but also at a position H2 close to the left end portion, which is a position immediately above the start button in FIG. 7B, and at a position H3 close to the right end portion, which is a position immediately above the power button in FIG. 7B, also serve as operation targets. Note that the light-emitting portions 311 and the light-receiving portions 312 to be activated are changed according to time. The light-emitting portions 311 and the light-receiving portions 312 belonging to the position H1, the position H2, and the position H3 are alternately activated, and the rest are inactivated. That is, the light-emitting portions 311 and the light-receiving portions 312 to be activated and the light-emitting portions 311 and the light-receiving portions 312 to be inactivated are changed according to time. Therefore, the position of the light-emitting portions 311 and the light-receiving portions 312 to be activated changes. When a time interval for changing the position is made short, even when the user touches any of the start button, the home button, and the power button, the optical detector 310 is able to detect the touch. Because the light-emitting portions 311 and the light-receiving portions 312 are activated impartially, deterioration of specific light-emitting portions 311 and light-receiving portions 312 may be prevented.

The light-emitting portions 311 and the light-receiving portions 312 to be activated may be determined in advance, or may be set by the user.

### Description of Control Device 500

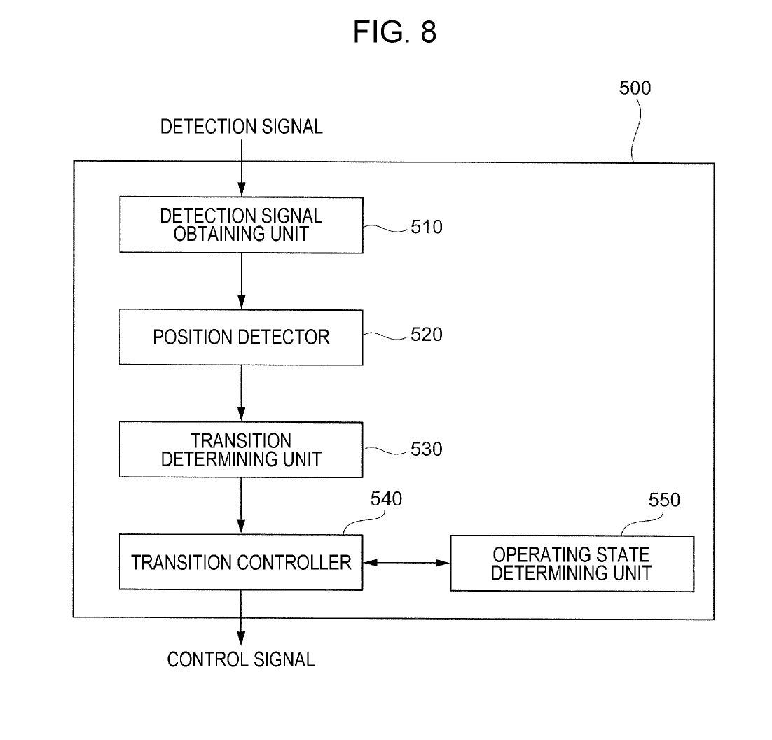

FIG. 8 is a block diagram illustrating an exemplary functional configuration of the control device 500. FIG. 8 illustrates, among different functions included in the control device 500, selective functions that are related to the exemplary embodiment.

The control device 500 is an example of a controller that controls the operation of the image forming apparatus 1 including the user interface 300.

As illustrated in FIG. 8, the control device 500 according to the exemplary embodiment includes a detection signal obtaining unit 510, a position detector 520, a transition determining unit 530, a transition controller 540, and an operation state determining unit 550.

The detection signal obtaining unit 510 obtains a detection signal from the optical detector 310. The detection signal includes information on the position of one or more light-receiving portions 312 having received light reflected from an object T of interest to be detected, and information on the intensity of the light received by the light-receiving portion(s) 312.

The position detector 520 obtains the position of the object T of interest on the basis of the detection signal obtained by the detection signal obtaining unit 510. The position is obtainable from information on which of the light-receiving portions 312 has/have received the light, and the intensity of the light received by the light-receiving portion(s) 312, as has been described using FIG. 4.

The transition determining unit 530 determines whether to transition from the power saving mode to the normal mode, on the basis of the position obtained by the position detector 520. That is, as described above, when the transition determining unit 530 determines from the position obtained by the position detector 520 that a transition receiving portion such as the home button has been touched, the transition determining unit 530 determines to transition from the power saving mode to the normal mode.

The transition controller 540 switches the operating state of the image forming apparatus 1 to one of the normal mode and the power saving mode (the low power mode and the sleep mode) in accordance with an instruction from the user and the operating conditions of the individual sections of the image forming apparatus 1. When the transition determining unit 530 determines to transition from the power saving mode to the normal mode, the transition controller 540 outputs a control signal for controlling the image forming apparatus 1 to transition from the power saving mode to the normal mode. Specifically, the temperature of the fixing device is increased to a normal fixing temperature. In addition, the power supply to each mechanism of the image forming apparatus 1, to which the power supply has been stopped in the power saving mode, is resumed to activate the mechanism. Also, all the light-emitting portions 311 and the light-receiving portions 312 are activated.

The operation state determining unit 550 determines which of the light-emitting portions 311 and the light-receiving portions 312 are to be activated and inactivated. In other words, in the power saving mode, the operation state determining unit 550 selects which of the light-emitting portions 311 and the light-receiving portions 312 are to be activated and inactivated. In the normal mode, all the light-emitting portions 311 and the light-receiving portions 312 are activated, and none of the light-emitting portions 311 and the light-receiving portions 312 is inactivated.

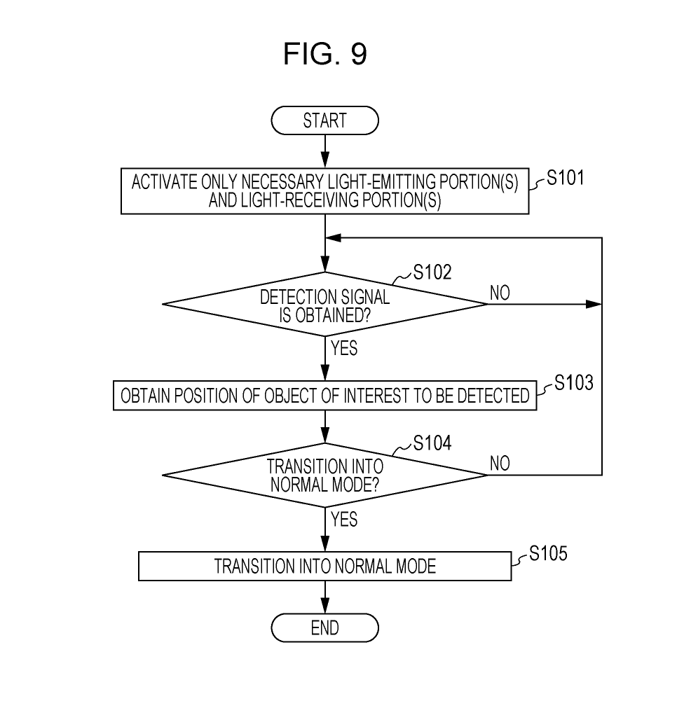

FIG. 9 is a flowchart illustrating the operation of the control device 500.

The illustrated operation of the control device 500, which will be described below, is the operation in the case of controlling the image forming apparatus 1 to transition from the power saving mode to the normal mode.

At first, in the power saving mode, the transition controller 540 activates one or more of the light-emitting portions 311 and one or more of the light-receiving portions 312 that are necessary for detecting a user operation on a transition receiving portion such as the home button, and inactivates the rest of the light-emitting portions 311 and the light-receiving portions 312 that are unnecessary (step S101). The operation state determining unit 550 determines which of the light-emitting portions 311 and the light-receiving portions 312 are to be activated and inactivated.

In this state, it is determined whether the detection signal obtaining unit 510 has obtained a detection signal from the optical detector 310 (step S102).

As a result, when no detection signal from the optical detector 310 has been obtained (NO in step S102), the process returns to step S102.

In contrast, when a detection signal from the optical detector 310 has been obtained (YES in step S102), the position detector 520 obtains the position of an object T of interest to be detected on the basis of the detection signal (step S103).

The transition determining unit 530 further determines whether to transition from the power saving mode to the normal mode, on the basis of the position of the object T of interest, obtained by the position detector 520 (step S104). That is, in response to a touch event on a transition receiving portion such as the home button, the transition determining unit 530 determines to transition from the power saving mode to the normal mode. In contrast, in response to a touch event on a portion other than the transition receiving portions, the transition determining unit 530 determines not to transition from the power saving mode to the normal mode.

As a result, when the transition determining unit 530 determines to transition from the power saving mode to the normal mode (YES in step S104), the transition controller 540 controls the image forming apparatus 1 to transition from the power saving mode to the normal mode (step S105). At this time, the operation state determining unit 550 activates all the light-emitting portions 311 and the light-receiving portions 312.

In contrast, when the transition determining unit 530 determines not to transition from the power saving mode to the normal mode (NO in step S104), the process returns to step S102.

According to the above-described exemplary embodiment, to transition from the power saving mode where the power consumption is less to the normal mode where the power consumption is greater in response to a user operation, even when the optical detector 310 is used to detect this operation, power consumed by the optical detector 310 is less likely to increase.

Although the exemplary embodiment is described using the image forming apparatus 1 by way of example in the above-described example, the exemplary embodiment is not limited to the image forming apparatus 1 and is applicable to any apparatus as long as it detects an object T of interest to be detected using the optical detector 310.

Although the image forming apparatus 1 may be regarded as a detection device including the optical detector 310 and the control device 500 in the above-described example, the function of the control device 500 may be included in the optical detector 310 or the user interface 300. In that case, the optical detector 310 or the user interface 300 serves as a detection device.

Although the case of a touch event in the first detection region R1 or the second detection region R2 has been described in the above-described example, not only a simple touch, but also a long touch may be detected. In this case, a touch event is determined as a long touch when an object T of interest to be detected remains unmoved at a position the user touches for a duration longer than a predetermined time period.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A receiving device comprising:
an optical detector that detects a position of an object of interest to be detected by receiving, with use of one or more of light-receiving portions, reflected light that occurs when light emitted from one or more of light-emitting portions is reflected by the object of interest to be detected; and
a transition receiving portion that receives, based on a detection result detected by the optical detector, an operation performed by a user for causing an apparatus including the receiving device to transition from a first power state where power consumption of the apparatus is less to a second power state where the power consumption is greater, wherein:
in the first power state, the optical detector activates one or more of the light-emitting portions and one or more of the light-receiving portions that are necessary for detecting an operation performed by the user on the transition receiving portion, and inactivates rest of the light-emitting portions and the light-receiving portions that are unnecessary.

2. The receiving device according to claim 1, further comprising:
a display that displays an image, wherein:
the transition receiving portion is provided at a position farther from the optical detector than the display.

3. The receiving device according to claim 2, wherein:
the transition receiving portion includes an identification display element with which the user is able to recognize an operation target, and
the optical detector detects whether the user has touched the transition receiving portion.

4. The receiving device according to claim 1, wherein:
the light-emitting portions and the light-receiving portions are arranged in line on the optical detector, and
the transition receiving portion is provided along a direction in which the light-emitting portions and the light-receiving portions are arranged.

5. The receiving device according to claim 4, wherein the one or more of the light-emitting portions and the one or more of the light-receiving portions to be activated and the rest of the light-emitting portions and the light-receiving portions to be inactivated are changed according to time.

6. A receiving device comprising:
an optical detector that detects a position of an object of interest to be detected by receiving, with use of one or more of light-receiving portions, reflected light that occurs when light emitted from one or more of light-emitting portions is reflected by the object of interest to be detected; and
a transition receiving portion that receives, based on a detection result detected by the optical detector, an operation performed by a user for causing an apparatus including the receiving device to transition from a first power state where power consumption of the apparatus is less to a second power state where the power consumption is greater, wherein:
in the first power state, the optical detector activates one or more of the light-emitting portions that emit light to the object of interest to be detected on the transition receiving portion, and one or more of the light-receiving portions that receive light reflected from the object of interest to be detected on the transition receiving portion, and inactivates rest of the light-emitting portions and the light-receiving portions.

7. A detection device comprising:
an optical detector that detects a position of an object of interest to be detected by receiving, with use of one or more of light-receiving portions, reflected light that occurs when light emitted from one or more of light-emitting portions is reflected by the object of interest to be detected; and
a controller that activates, in a first power state where power consumption of an apparatus including the detection device is less, one or more of the light-emitting portions and one or more of the light-receiving portions that are necessary for detecting an operation performed by a user on a transition receiving portion, and inactivates rest of the light-emitting portions and the light-receiving portions that are unnecessary, the transition receiving portion receiving, based on a detection result detected by the optical detector, an operation performed by the user for causing the apparatus to transition from the first power state to a second power state where the power consummation is greater.
